(19) United States
(12) Patent Application Publication
(10) Pub. No.: US 2007/0162448 A1
(43) Pub. Date: Jul. 12, 2007

(54) Adaptive hierarchy structure ranking algorithm

(76) Inventors: Ashish Jain, Richardson, TX (US); Srikanth P. Soogoor, Richardson, TX (US)

Correspondence Address: MICHAEL L. DIAZ, P.C., 555 REPUBLIC DRIVE, SUITE 200, PIANO, TX, 75074, US

(21) Appl. No.: 11/328,342

(22) Filed: Jan. 10, 2006

(51) Int. Cl. G06F 7/00; G06F 17/30

(52) U.S. Cl. 707/7; 707/101

(57) ABSTRACT

The present invention is a method for ranking a plurality of documents during a search query utilizing a hierarchical keyword ranking scheme. The present invention utilizes an algorithm which determines a level value for each searched page in the plurality of documents. The algorithm then ranks each page from the plurality of documents by extracting keywords from each document and determining a page keyword rank for each searched page. Next, a hierarchical keyword rank is determined based upon the level value and the page keyword rank for each page. This hierarchical keyword rank is used to rank order the searched documents in order of importance.

### FIELD OF THE INVENTION

This invention relates to algorithms utilized in search engines for websites and databases. Specifically, the present invention relates to a method providing a hierarchy structure ranking of websites and databases.

### DESCRIPTION OF THE RELATED ART

In recent years, developments in computer technology and the increase in the usage of computers have encouraged large numbers of people to access and search for data. Internet search engines are often used to search the entire World Wide Web. For example, a popular search engine might perform over 30 million searches per day of the indexable portion of the Internet, which has a size exceeding 500 gigabytes. Needless to say, search engines are judged on the quantity and quality of their search results. Currently, the quality of the search results is oftentimes poor. Large number of documents, such as located on the Internet, typically contains many low quality documents. As a consequence, a search result will return numerous irrelevant or unwanted documents which make it difficult to recognize the relevant results or documents. In order to improve the selectivity of these results, existing techniques allow the user to restrict the scope of the search to a specific subset of website or to provide additional keyword search terms. Although these techniques are effective in some cases, these techniques are not always effective because some relevant-documents or web pages may be missed by restricting the scope of the user's search.

Existing search engines utilize various techniques that attempt to present more relevant documents or web pages to the user. In one popular technique, documents are ranked according to variations of a standard vector space model. The variations could include such factors as how recent the document was updated or how close the search terms are to the beginning of the document. However, although this technique does attempt to rank the relevancy of the document or web page, the search results and ranking do not reflect the quality of the content of the documents or web pages searched. In another technique, the documents or web pages are based on an objective ranking based on the relationship between the documents or web pages. Rather than base the rank on the importance of the content, this technique ranks the relevancy of the document or web pages by examining the extrinsic relationship between documents or web pages. Specifically, the importance of a document or web pages, regardless to its content, is ranked by the number of citations the documents or web pages receives from other sources. Thus, a highly cited document or web pages is ranked high in a search result. Another technique entitled Page Rank (from Google) base their rank index on citations a document or web page receives from other documents or web pages, but also store the proximity of keywords in the document or web pages for search result extraction.

Although these existing techniques provide some higher quality search results than without any type of ranking, existing search techniques suffer from several serious drawbacks. First, the documents or web pages that are searched are not ranked based on the structure of the document or web pages, but rather on the popularity or number of citations that a document or web page receives or on certain vector space model. Thus, existing search techniques do not actually rank documents or web pages based on how it relates to its predecessors and/or ancestors contents except for considering the citation popularity. The second drawback that existing search technologies suffer from is that they perform centralized crawling and indexing that do not allow for distributed document or web page crawling. With the Internet constantly growing in size and data volume, the existing search technologies would require large investments in infrastructure. Thirdly, the current techniques are highly susceptible to “spamming” to inflate the relevancy of the document. For example, a document or web page may include several other documents or web pages which cite the other document or web pages numerous times to inflate the relevancy of the document or web page. Thus, the document or web page may be of poor quality, but ranked higher than documents or web page having true relevancy to the search results. Fourthly, existing search techniques index or rank a limited number of dynamic documents or web pages, thereby making them inefficient or ineffective for web site or enterprise search containing lots of dynamic web content. A search technique and algorithm is needed which ranks the documents or web pages (static and dynamic) based on structural relationships of a document or a web page to its predecessors and ancestors with emphasis on content correlation rather than relying on external factors.

Thus, it would be a distinct advantage to have an algorithm which enables a search engine to rank documents or web pages (static and dynamic) in distributed manner and directly utilize these ranks to efficiently and effectively determine the relevant documents or web pages without the need for centralized crawling or ranking. It is an object of the present invention to provide such a method.

### SUMMARY OF THE INVENTION

The present invention is a computer implemented method for ranking a plurality of documents or web pages for a search query. The method begins by determining a structural level value for each searched document or web page in the plurality of documents or web pages. Each document or web page is then ranked by extracting keywords from each document or web page and determining a page keyword rank for each page. A hierarchical keyword rank is determined by combining the structural level value and the page keyword rank for each page.

The hierarchy of documents or web pages crawled defines the structure in the present invention's ranking algorithm. Thus, if a document or web page contains a reference to a document or page that has not already been referred to earlier, the present document or web page is considered to be the parent and the new document or web page is considered to be the child. Next, each page is ranked by extracting keywords from each document or web page and determining a page keyword rank for each page. A hierarchical keyword rank is calculated based upon relationships between parent and child documents or web pages and the page keyword rank for each document or web page.

Each page may be ranked by extracting keywords from each document or web page and determining a page keyword rank for each page by utilizing the formula Σfreq_{tag}×Rank_{tag} to determine keyword rank wherein freq_{tag} is a preset frequency for each tag and Rank_{tag} is a preset rank per occurrence for each tag. The keyword rank is then saved as Log₁₀(keyword rank×10).

### BRIEF DESCRIPTION OF THE DRAWINGS

FIG. 1 illustrates a graphical relational representation of an exemplary plurality of pages in the preferred embodiment of the present invention;

FIG. 2 provides an exemplary textual representation of the hierarchical keyword rank in the preferred embodiment of the present invention;

FIG. 3 is a flow chart outlining the steps for extracting a child URL from an examined page according to the teachings of the present invention;

FIG. 4 is a flow chart outlining the steps for ranking keywords in a document according to the teachings of the present invention; and

FIG. 5 is a flow chart outlining the steps for determining the hierarchical keyword ranking according to the teachings of the present invention.

### DESCRIPTION OF THE INVENTION

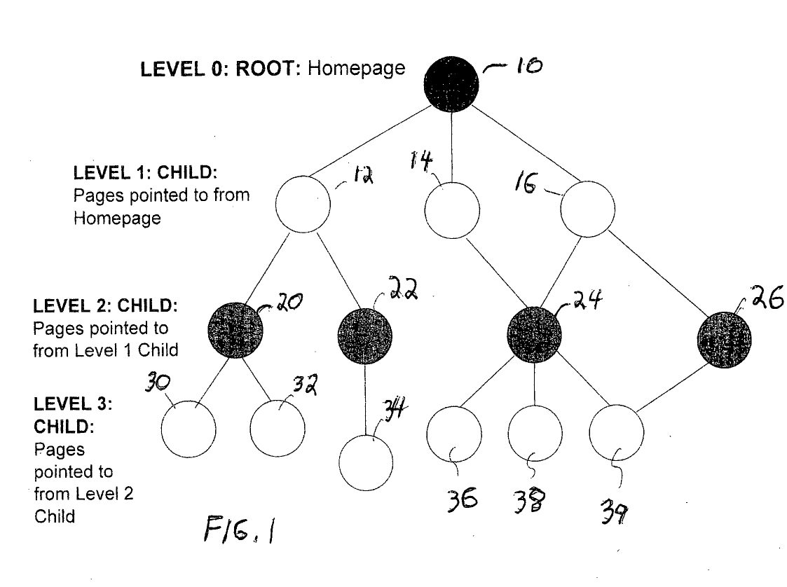

The present invention is a hierarchy structure-ranking algorithm for use in a search engine. Documents and web pages, such as found on the Internet, may be effectively searched and ranked by the present invention. FIG. 1 illustrates a graphical relational representation of an exemplary plurality of pages in the preferred embodiment of the present invention. FIG. 1 provides a graphical representation of a typical website. A home page 10 is also represented as the root at Level “0.” From the homepage are a plurality of child pages 12, 14, and 16 denoted as level “1.” The child page 12 points to child pages 20 and 22 and are denoted as level “2.” Child page 20 points to two of its child pages 30 and 32. Likewise, child page 22 points to child page 34. Child pages 30, 32, and 34 are assigned to level “3.” Additionally, child page 14 and child page 16 both point to child page 24. Child page 16 also points to child page 26. Child page 24 and child page 26 are located at level 2. Child page 24 points to child pages 36, 38 and 39. Child page 26 also points to child page 39. Child pages 36, 38, and 39 are located at level 3. It should be understood that FIG. 1 is an example of a simplified website (document). The document or web page may have more or less child pages and levels.

The relationship illustrated in FIG. 1 may be exemplified by a popular website such as www.cnn.com. The homepage 10 may be the homepage of www.cnn.com. Home page 10 may include three level 1 child pages 12, 14, and 16, such as “sports,” “business,” and “politics.” The child page 12 may represent sports and may include two child pages 20 and 22 represented as “football” and “basketball.” The football and basketball pages 20 and 22 are level 2 child pages. The football child page 20 may include “college” and “professional” child pages 30 and 32 at level 3. Likewise, the basketball child page 22 may include a “professional” child page 34 at level 3. Business child page 14 and politics child page 16 may both point to the child page 24 which represent an “international” page. Politics child page 16 may also point to child page 26 represented as “opinions.” Child pages 24 and 26 are at level 2. International child page 24 may point at child pages 36, 38, and 39 which may represent “international business,” “international politics,” and “international weather.” Child pages 36, 38, and 39 are level 3 children.

FIG. 1 shows the structural hierarchy normally found on a plurality of pages located at most websites. Analyzing the structure and the content of these pages is critical and unique in the present invention. The present invention utilizes an algorithm which extracts the child URL from each page, ranks keywords for each page, and determines a hierarchical keyword rank. The hierarchical keyword rank is utilized as the rank for ordering the searched documents. The high quality of search results is based on the fact that parent pages either discuss a certain topic or point to pages (child pages) that discuss the topic. Hence the correlation between keywords in parent and child pages allows the search engine to extract and display appropriate documents or web pages that have structural and often symbolic relevance within a website and in comparison to other website content. This fact is utilized by the algorithm. As an example, a search for “cnn business news” will first yield pages from “www.cnn.com”>“news”>“business” sections as compared to other pages with these keywords.

With regards to child URL extraction, the algorithm begins by extracting the child URL from within <a href=“ . . . ”> tag for each page. If the extracted child URL is not a duplicate, a new level value is assigned to the URL and saved in an array marked as “duplicates.” Next, this page is assigned as a parent of the child URL. Next, if the child page is a duplicate and the level is greater than the current page level, the current page is assigned as parent of the child URL. The currently viewed page content is then saved.

To analyze the content of each page, keyword ranking is a critical part of the present invention. Each page is ranked by extracting keywords from within various tags, such as <title>, <url>, <meta>, <h1 . . . 6>, <alt img>, <b>, <u>, <i>, <body>, etc. Based on a preset frequency of each tag, and a preset rank per occurrence on a scale of 0 to 100, a keyword rank is determined for each page. Specifically, the formula is represented as:
keyword rank=Σfreq_{tag}×Rank_{tag}
The keyword rank is saved as:
Log₁₀(keyword rank×10) if keyword !=0, else ignore
Thus, the keyword range falls between (0, 3]

The hierarchical keyword rank provides a unique methodology of ranking the different keywords, depending on the position within the document. For the level 0 page, the children are extracted for level 0, which equate to level 1 children. Thus, as shown in FIG. 1, home page 10 at level 0 extracts three level 1 child pages 12, 14, and 16. For each level 1 child page, the child pages are extracted and are equated as level 2 child pages. For example, the level 1 child page 12 may extract level 2 child pages 20 and 22. Likewise, child pages 14 and 16 may extract the child pages at level 2. Next, each level 2 page includes extracted level 3 child pages. For example, examining level 2 child page 20 may yield level 3 child pages 30 and 32. Likewise, each level 3 page is analyzed and the algorithm extracts the children from level 3. In FIG. 1, there are no such child pages of level 3. For each keyword in the parent level 2 (child pages 20, 22, 24, and 26) and child level 3 pages (child pages 30, 32, 34, 36, 38, and 39), the total parent keyword rank is equal to the parent keyword rank plus the child keyword rank(s). Thus, the keywords at the upper parent level are worth both the keyword at the parent level and the keyword at the child level. Likewise, for each keyword in parent level 1 (child pages 12, 14, and 16) and child pages at the child level 2 (child pages 20, 22, 24, and 26), the total parent keyword rank is equal to the parent keyword rank plus the child keyword rank. In addition, for each keyword in parent level 0 (homepage 10) and child level 1 (child pages 12, 14, and 16), the total parent keyword rank is equal to the parent keyword rank plus the child keyword rank.

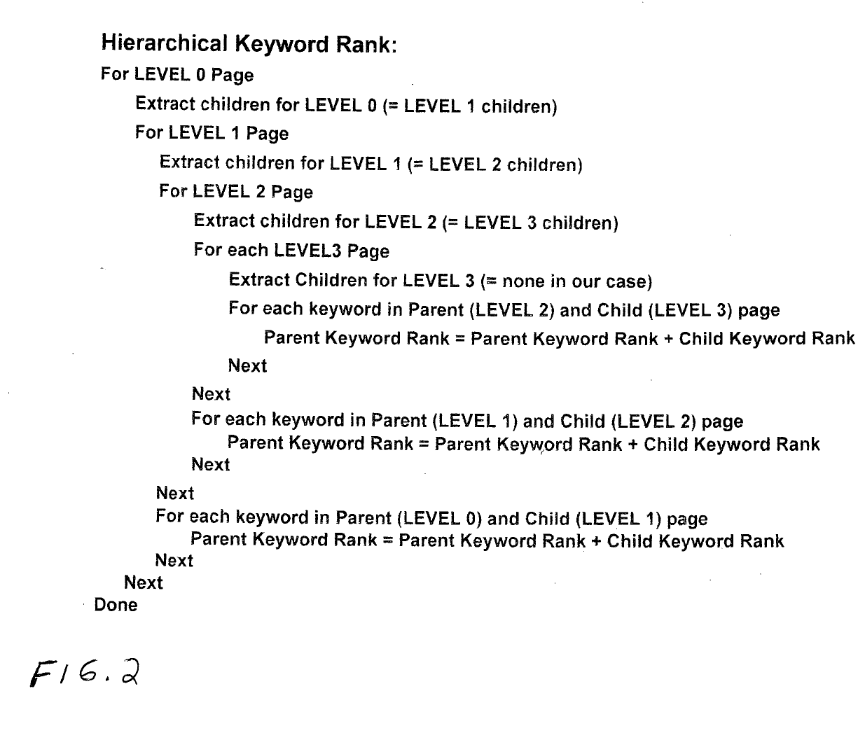

FIG. 2 provides an exemplary textual representation of the hierarchical keyword rank in the preferred embodiment of the present invention. The present invention utilized the algorithm textually represented in FIG. 2 to determine the hierarchical keyword rank for each page and its child page.

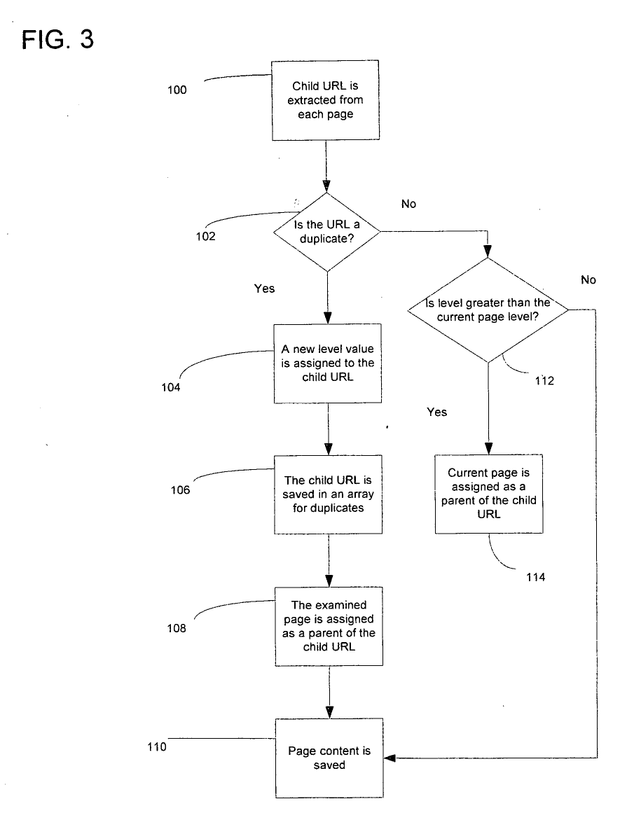

FIG. 3 is a flow chart outlining the steps for extracting a child URL from an examined page according to the teachings of the present invention. With reference to FIGS. 1 and 3, the steps of the method will now be explained. The method begins with step 100 wherein a child URL is extracted from each page. For each page, the child URL is extracted from within <a href=“ . . . ”> tag. Next, in step 102, it is determined if the extracted URL is a duplicate. In step 102, if it is determined that the extracted URL is not a duplicate, the method moves to step 104 where a new level value is assigned to the child URL. The method then moves to step 106 where the child URL is saved in an array for duplicates. This array is searched to determine if the extracted URL is a duplicate. Next, in step 108, the examined page is then assigned as a parent of the child URL. The method then moves to step 110 wherein the current examined page content is saved. However, in step 102, if it is determined that the extracted URL is a duplicate, the method moves to step 112 where it is determined if the level is greater than the current page level. If the level is greater than the current page level, the method moves to step 114 where the current page is assigned as a parent of the child URL. The method then moves from step 114 to step 110 where the current examined page content is then saved. However, in step 112, if it is determined that the level is not greater than the current page level, the method moves from step 112 to step 110 where the current examined page content is saved.

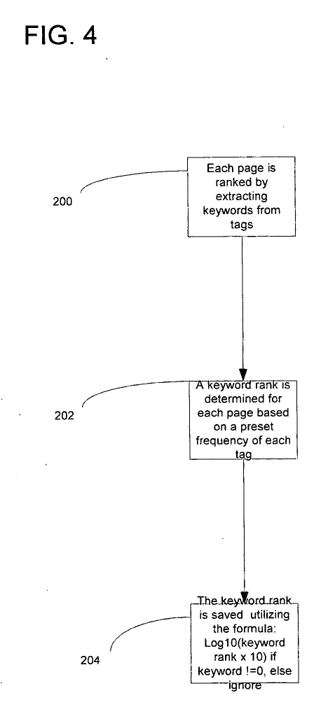

FIG. 4 is a flow chart outlining the steps for ranking keywords in a document according to the teachings of the present invention. With reference to FIGS. 1, 3, and 4, the steps of the method will now be explained. The method begins in step 200 where each page is ranked by extracting keywords from within various tags such as <title>, <url>, <meta>, <h1 . . . 6>, <alt img>, <b>, <u>, <i>, <body>, etc. Next, in step 202, a keyword rank is determined for each page based on a preset frequency of each tag, and a rank per occurrence on a scale of 0 to 100. Specifically, the formula is represented as:
keyword rank=Σfreq_{tag}×Rank_{tag}
Next, in step 204, the keyword rank is saved as:
Log₁₀(keyword rank×10) if keyword !=0, else ignore
Thus, the keyword range falls between (0,3].

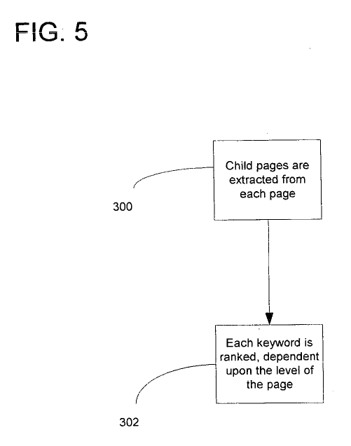

FIG. 5 is a flow chart outlining the steps for determining the hierarchical keyword ranking according to the teachings of the present invention. With reference to FIGS. 1, 2, 3, 4, and 5, the steps of the method will now be explained. The hierarchical keyword rank provides a unique methodology of ranking the different keywords, depending on the position within the document. The method begins with step 300, where child pages are extracted from each page. Thus, for the level 0 homepage, the children are extracted for level 0, which are denoted as level 1 children. Likewise, for each level 1 child page, the child pages are extracted and are equated as level 2 child pages. In addition, for each level 2 child page, level 3 child pages are extracted. This extraction process continues for all levels present in the document. Next, in step 302, each keyword is ranked, dependent upon the level of the page. For example, for each keyword in the parent level 2 (child pages 20, 22, 24, and 26) and child level 3 pages (child pages 30, 32, 34, 36, 38, and 39), the total parent keyword rank is equal to the parent keyword rank plus the child keyword rank. Thus, the keywords at the upper parent level are worth both the keyword at the parent level and the keyword at the child level. Likewise, for each keyword in parent level 1 (child pages 12, 14, and 16) and child pages at the child level 2 (child pages 20, 22, 24, and 26), the parent keyword rank is equal to the parent keyword rank plus the child keyword rank. In addition, for each keyword in parent level 0 (homepage 10) and child level 1 (child pages 12, 14, and 16), the parent keyword rank is equal to the parent keyword rank plus the child keyword rank. The process is repeated for each page and for every document. Thus, the searching algorithm, extracts the child URL from each document, ranks the keywords, and provides a hierarchical keyword rank. This process provides a high quality search result.

The present algorithm generates ranks that can be stored as searchable index and utilized in a search engine. The algorithm ranks the documents or web pages according to the structure and content of the pages. The present invention provides many advantages over existing algorithm. The present invention analyzes the structure of each document as well as the keywords within each page to determine an appropriate rank order of each document. This ranking algorithm provides a superior methodology for searching vast amounts of information. It allows for distributed crawling, ranking and indexing of documents and web pages.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A computer implemented method for ranking a plurality of documents and web pages for search, the method comprising the steps of:
determining a level value for each searched page in the plurality of documents and web pages by utilizing distributed crawling;
ranking each page from the plurality of documents and web pages by extracting keywords from each document and determining a page keyword rank for each page; and
determining a hierarchical keyword rank based upon the level value and the page keyword rank for each page.

2. The computer implemented method for ranking a plurality of documents of claim 1 wherein the step of determining a level value for each page includes the steps of:
extracting a child URL from a tag within the searched page;
assigning a level value to the searched page;
classifying the searched page as a parent of the child URL; and
saving the searched page content.

3. The computer implemented method for ranking a plurality of documents of claim 2 wherein the step of assigning a level value to the searched page includes the steps of:
determining if the searched page is a duplicate page; and
if the page is not a duplicate page, assigning a level value to the searched page and saving the searched page in an array for duplicate pages.

4. The computer implemented method for ranking a plurality of documents of claim 1 wherein the step of ranking each page from the plurality of documents by extracting keywords from each document and determining a page keyword rank for each page includes the steps of:
utilizing a formula of:
Σfreq_{tag}×Rank_{tag} to determine keyword rank wherein freq_{tag} is a preset frequency for each tag and Rank_{tag} is a rank per occurrence for each tag; and
saving the keyword rank as Log₁₀(keyword rank×10).

5. The computer implemented method for ranking a plurality of documents of claim 1 wherein the step of determining a hierarchical keyword rank based upon the level value and the page keyword rank for each page includes the step of combining the searched page keyword rank with the keyword rank of any child pages associated with the searched page to form the hierarchical keyword rank.

6. A computer implemented method for ranking a plurality of documents during a search query, the method comprising the steps of:
determining a level value for each searched page in the plurality of documents, wherein the step of determining a level value includes the steps of:
extracting a child URL from a tag within the searched page;
assigning a level value to the searched page;
classifying the searched page as a parent of the child URL; and
saving the searched page content;
ranking each page from the plurality of documents by extracting keywords from each document and determining a page keyword rank for each page; and
determining a hierarchical keyword rank based upon the level value and the page keyword rank for each page, the hierarchical keyword rank being based upon the searched page keyword rank with the keyword rank of any child pages associated with the searched page.

7. The computer implemented method for ranking a plurality of documents of claim 6 wherein the step of ranking each page from the plurality of documents by extracting keywords from each document and determining a page keyword rank for each page includes the steps of:
utilizing a formula of:
Σfreq_{tag}×Rank_{tag} to determine keyword rank wherein freq_{tag} is a preset frequency for each tag and Rank_{tag} is a rank per occurrence for each tag; and
saving the keyword rank as Log₁₀(keyword rank×10).

8. The computer implemented method for ranking a plurality of documents of claim 6 wherein the step of assigning a level value to the searched page includes the steps of:
determining if the searched page is a duplicate page; and
if the page is not a duplicate page, assigning a level value to the searched page and saving the searched page in an array for duplicate pages.
